(19) United States
(12) Patent Application Publication
(10) Pub. No.: US 2005/0180291 A1
(43) Pub. Date: Aug. 18, 2005

(54) Recording and reproducing method

(75) Inventor: Masakazu Ogasawara, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/047,687

(22) Filed: Feb. 2, 2005

(30) Foreign Application Priority Data
Feb. 13, 2004 (JP) P2004-036544

(51) Int. Cl. G11B 7/00

(52) U.S. Cl. 369/103

(57) ABSTRACT

A hologram recording method for forming a light interference pattern in a hologram recording medium to record information thereon. The method includes a step of interfering with a reference beam a signal beam spatially modulated by an information pattern which carries the information to generate interfered beams. The method includes a step of executing a recording sequence a plurality of times, the recording sequence including steps of irradiating the interfered beams onto a recording surface of the hologram recording medium to form a group of a plurality of holograms each corresponding to the information pattern. The method includes a step of completing the recording sequence. Different modulation conditions are set for at least one of the signal beam and the reference beam in one recording sequence and the subsequent recording sequence immediately after the one recording sequence.

### BACKGROUND OF THE INVENTION

1. Field of the Invention

The present invention relates to a hologram recording medium with which information is optically recorded or reproduced, and more particularly, to a method for recording information on the hologram recording medium.

2. Description of the Related Art

A hologram has drawn attention because of its ability to record two-dimensional data at a high density, for use in high density information recording. The hologram is characterized by volumetrically recording a light wavefront, which carries recording information, on a hologram recording medium made of a photosensitive material such as a photo-refractive material as a change in refractive index. Multiplex recording on the hologram recording medium can dramatically increase the recording capacity. The multiplex recording is classified into angle multiplexing, phase coding multiplexing, and the like. Even in a multiplexed hologram region, information can be recorded multiple times by changing the incident angle or phase of interfering light waves.

An optical information recording apparatus with phase coding multiplexing has been developed for recording information at an ultra high density using the hologram recording medium having a disk-shape (see, for example, Laid-open Japanese Patent Application No. 2002-123949). For recording an interference fringe pattern of a hologram, a proper exposure time and energy are required in a relative static state both of the hologram recording medium and writing light, so that this prior art provides a method of continuing to precisely expose the moving hologram recording medium at a recording position thereof.

The conventional phase coding multiplexing involves changing a modulating condition of a phase modulator (spatial light modulator) for reference light per each time that a hologram of one data pattern is recorded. Specifically, for recording, a spatial light modulator for signal light selects a transparent state and a blocking state on a pixel-by-pixel basis in accordance with information to be recorded to spatially modulate the light which passes therethrough, to generate information light in a predetermined pattern. Simultaneously, the phase modulator for reference light selectively gives a phase difference of zero (rad) or p (rad) to passing light on a pixel-by-pixel basis based on a predetermined phase in accordance with a predetermined modulation pattern. Thereby the phase of the reference light is spatially modulated to generate recording reference light. The phase modulated reference light and information light interfere with each other. For reproduction, on the other hand, all pixels of the spatial light modulator for signal light block up the light-passage state and the phase modulator generates the reference light, the spatial phase of which is modulated by a predetermined amount to passing light in accordance with a predetermined modulation pattern.

In the prior art, the modulation state of the phase modulator is switched each time a hologram of one data pattern is recorded. Thus, excessive burden is imposed on a circuit for driving the phase modulator, and a complicated control is involved therein.

### SUMMARY OF THE INVENTION

It is therefore an exemplary object of the present invention to provide a recording method which enables to precisely perform multiplex recording a plurality of times, and stably recording or reproducing information.

A hologram recording method according to the present invention is a hologram recording method for forming a light interference pattern in a hologram recording medium to record information thereon, characterized by comprising the steps of:
interfering with a reference beam a signal beam spatially modulated by an information pattern which carries the information to generate interfered beams;
executing a recording sequence a plurality of times, the recording sequence including steps of irradiating the interfered beams onto a recording surface of the hologram recording medium to form a group of a plurality of holograms each corresponding to the information pattern; and
completing the recording sequence,
wherein different modulation conditions are set for at least one of the signal beam and the reference beam in one recording sequence and the subsequent recording sequence immediately after the one recording sequence.

### BRIEF DESCRIPTION OF THE DRAWINGS

The aforementioned aspects and other features of the invention are explained in the following description, taken in connection with the accompanying drawing figures wherein:

FIG. 1 is a partial perspective view generally showing a hologram disk with a track structure according to one embodiment of the present invention;

FIG. 2 is a partial plan view generally showing the hologram disk with the track structure according to one embodiment of the present invention;

FIG. 3 is a partial cross-sectional view generally showing a hologram disk according to another embodiment of the present invention;

FIG. 4 is a block diagram generally showing the configuration of a recording and/or reproducing apparatus for recording or reproducing information to or from a hologram disk according to one embodiment of the present invention;

FIG. 5 is a perspective view generally showing a pickup of the recording and reproducing apparatus for recording and reproducing information to/from a hologram disk according to one embodiment of the present invention;

FIGS. 6 and 7 are schematic diagrams each generally showing a configuration of the pickup of the recording and reproducing apparatus for recording and reproducing information to/from a hologram disk according to one embodiment of the present invention;

FIGS. 8 and 9 are plan views each illustrating tracks on a hologram recording medium to show a recording procedure according to one embodiment of the present invention;

FIG. 10 is a front elevation showing a phase modulator in the pickup of the recording and reproducing apparatus for recording and reproducing information to/from a hologram disk according to an embodiment of the present invention;

FIG. 11 is a plan view illustrating tracks on a hologram recording medium to show a recording procedure according to one embodiment of the present invention;

FIG. 12 is a front elevation showing a phase modulator in the pickup of the recording and reproducing apparatus for recording and reproducing information to/from a hologram disk according to another embodiment of the present invention;

FIG. 13 is a flow chart showing a recording procedure for recording on a hologram recording medium according to one embodiment of the present invention;

FIG. 14 is a block diagram generally showing the configuration of the pickup of the recording and reproducing apparatus for recording and reproducing information to/from a hologram disk according to one embodiment of the present invention;

FIG. 15 is a block diagram generally showing the configuration of the pickup of the recording and reproducing apparatus for recording and reproducing information to/from a hologram disk according to another embodiment of the present invention;

FIGS. 16 and 17 are front elevations each showing a spatial light modulator in the pickup of the recording and reproducing apparatus for recording and reproducing information to/from a hologram disk according to another embodiment of the present invention;

FIG. 18 is a flow chart showing a recording procedure for recording on a hologram recording medium according to another embodiment of the present invention;

FIG. 19 is a perspective view showing a hologram disk according to an embodiment of the present invention;

FIG. 20 is a perspective view showing a hologram optical card according to another embodiment of the present invention; and

FIG. 21 is a perspective view showing a hologram recording medium of disk accommodated in a case according to another embodiment of the present invention.

### DETAILED DESCRIPTION OF THE INVENTION

In the following, embodiments according to the present invention will be described with reference to the drawings.

<Hologram Recording Medium>

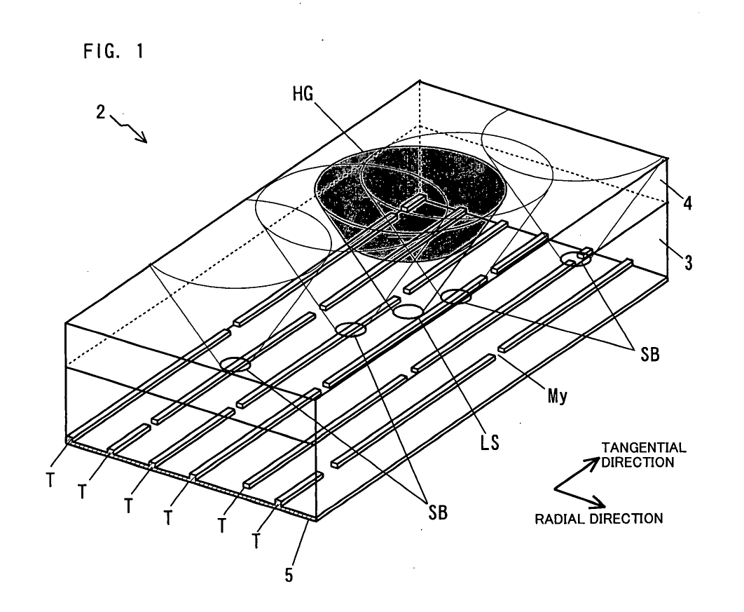

FIG. 1 shows a disk-shaped hologram recording medium according to an exemplary embodiment of the present invention.

A hologram disk 2 comprises a disk-shaped substrate 3 made of an optically transparent material, and a recording layer 4 carried on a main surface of the substrate and made of a photo-sensitive material.

The recording layer 4 for preserving an optical interference pattern is made of a photo-sensitive material such as a photo-refractive material, a hole burning material, a photo-chromic material or the like, which is used for enabling information to be recorded or reproduced with light which passes through the recording layer.

A reflective layer 5 is laminated on the opposite side of the substrate 3 from the main surface on which the recording layer 4 is laminated. The substrate 3 functions as a separation layer interposed between the recording layer 4 and reflective layer 5. The transparent substrate should not prevent light from impinging thereon, so that the hologram recording medium is given a proper intensity of light. In this way, an optical hologram recording medium can be implemented in such a scheme that light impinges on the substrate 4 and reflective layer 5 from the recording layer 4. Though not particularly limited, the material of which the substrate is made may be, for example, glass, polycarbonate, amorphous polyolefin, polyimide, plastics such as PET, PEN, PES, ultraviolet curing acrylic resin, and the like. The substrate should typically have a thickness on the order of 0.1-0.2 mm. The substrate may be formed with concavo-convex pits and/or guiding grooves, or the like, corresponding to address information and the like, on both sides or one side. Their pitch may be on the order of 0.3 to 1.6 mm, with a level difference on the order of 30-200 nm.

The material for the reflective layer 5 may be Al, Au, Ag, or an alloy thereof. The reflective layer 5 may have a thickness, for example, in a range of approximately 30 to 100 nm. A film made of these materials can be formed by known methods such as a sputtering method, a vapor deposition method, and the like.

An optically transparent cover layer (not shown) can be disposed on the outer surface of the recording layer 4.

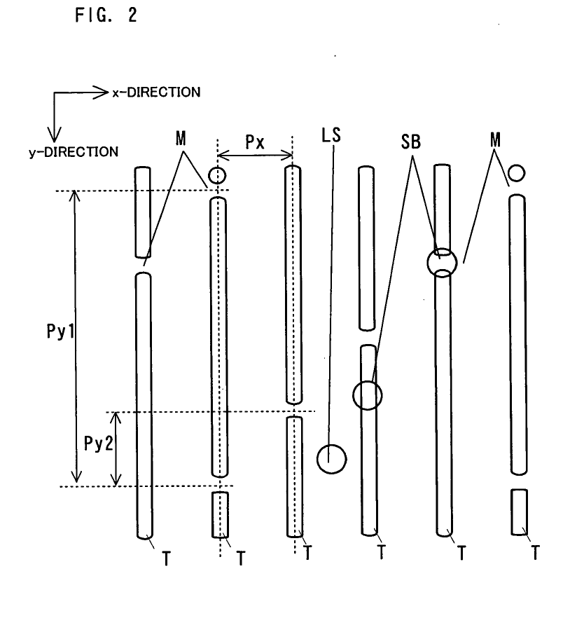

At the interface of the substrate 3 with the reflective layer 5, grooves are formed at a first pitch, and extend without intersection, as a plurality of tracks T. For conducting a tracking servo control, the tracks T are formed spirally or concentrically on the substrate with respect to the center thereof, or in a plurality of cut spiral arcs. The interface functions as a guide layer on which the tracks are formed. The tracking servo forces a recording light beam (reference light and signal light) LS to follow between adjacent tracks T on the reflective layer 5 during recording and reproduction. As shown in FIGS. 1 and 2, for example, the optical axis of the recording light beam LS is defined such that the recording light beam LS is positioned at the center of light spots of four servo beams SB arranged in a linear fashion, to conduct the tracking servo control to record holograms on the recording layer 4 over a mirror face region between adjacent tracks. The holograms HG or groups thereof may be in a spatial position overlapping partly each other. The holograms HG or groups thereof may be are aligned each other to make a longitudinal region along the track T, as seen from FIGS. 1 and 2.

The tracking servo is conducted by driving an objective lens by an actuator in accordance with a detected signal, using a pickup which includes a light source for emitting a light beam, an optical system including an objective lens for converging the light beam on the reflective layer 5 as a light spot and leading its reflected light to a photodetector, and the like. The diameter of the light spot is set to be narrowed down to a value determined by the wavelength of the light beam and the numerical aperture (NA) of the objective lens (a so-called diffraction limit which is, for example, 0.821/NA (1=wavelength), but is determined only by the wavelength of light and the numerical aperture when aberration is sufficiently small as compared with the wavelength). In other words, the light beam radiated from the objective lens is used such that it is focused when the reflective layer lies at the position of its beam waist. The width of the grooves is determined as appropriate in accordance with the output of the photodetector which receives the reflected light from the light spot, for example, a push-pull signal.

As shown in FIG. 2, a first pitch, i.e., a track pitch Px (x-direction) of the tracks T on the reflective layer 5 is set as a predetermined distance which is determined by the multiplicity of holograms HG recorded above the spot of the light beam LS. The multiplicity of holograms is determined by the characteristics of the hologram recording medium, NA of the objective lens, and the like. For example, an article of D. Psaltis, M. Levene, A. Pu, G. Barbastathis and K. Curtis, “Holographic storage using shift multiplexing” OPTICS LETTERS Vol. 20, No. 7 (Apr. 1, 1995), pp. 782-784 shows that a logical minimum distance by which adjacent holograms can be independently separated when a spherical reference wave is used, i.e., a minimum traveling distance in the shift multiplex recording scheme, is determined by the wavelength of signal light, the distance between an objective lens and a hologram recording medium, the thickness of the hologram recording medium, an angle at which the signal light intersects with the spherical reference wave, and the numerical aperture of the objective lens. With an actual hologram recording medium, when a subsequently recorded hologram is superimposed on a previously recorded hologram substantially at the same position, part of the previously recorded hologram is erased by the subsequently recorded hologram. A maximum multiplicity in an actual shift multiplex recording hologram system (i.e., a value (number of times) indicating how many independent holograms can be recorded within the same volume in a hologram recording medium) is determined by the medium and the configuration of the apparatus, as mentioned above. A minimum track pitch Px (i.e., a minimum shift distance) is set by a span of a recorded hologram area divided by the maximum multiplicity. The track pitch Px is set at the minimum shift distance or more. In other words, the track pitch Px is set at a value determined by the center-to-center distance of a pair of holograms, which are in closest proximity, of a plurality of holograms to be formed on the recording layer. Here, “a pair of holograms in close proximity” refers to a pair of holograms, the spatially existing ranges of which are adjacent to each other, so that the peripheries thereof are in close proximity, in contact, or partially overlapping.

For precisely positioning the recording light beam LS in this embodiment, a y-direction positioning mark M is formed on the reflective layer 5. The y-direction positioning mark M is disposed such that the respective marks are spaced apart by a mark pitch Py1 (second pitch) in a direction in which the tracks T extend (y-direction), and the mark pitch Py1 is a function of the track pitch Px.

For example, the mark pitch Py1 of the y-direction positioning marks M on the same track is assumed to have a size larger than the track pitch Px substantially by a factor of an integer. On the other hand, an adjoining pitch Py2 between the y-direction positioning marks M on adjacent tracks in the y-direction is assumed to have substantially the same length as the track pitch Px. With this track structure on the hologram disk, a light spot can be precisely moved between adjacent tracks to be recorded. A normal optical disk requires only positioning (tracking servo) in a direction (x-direction) perpendicular to a direction (y-direction) in which tracks extend, so that a position cannot be precisely determined in the x- and y-directions. On the contrary, in this embodiment, precise multiplex recording can be achieved a plurality of times by providing the y-direction positioning marks M in the track structure for use in the positioning in the y-direction.

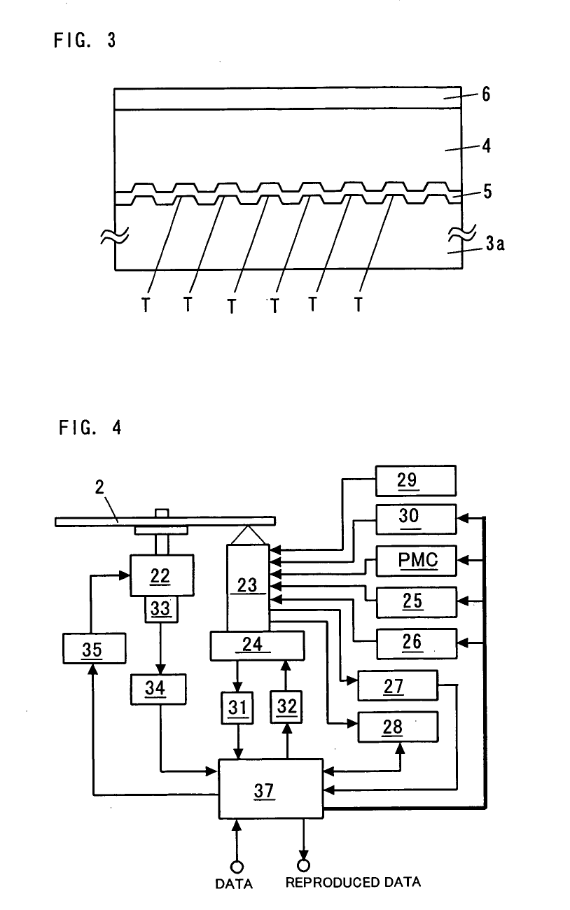

The foregoing embodiment has shown a hologram recording medium, the structure of which has a guide layer (reflective layer 5) and the recording layer 4 laminated with intervention of a separation layer (substrate 3). Besides, a hologram recording medium in another embodiment may have a reflective layer 5, a recording layer 4, and an optically transparent cover layer 6 sequentially laminated on a substrate 3a formed with tracks T, a y-direction positioning mark M and the like, without including a separation layer, as shown in FIG. 3. Also, an exemplary modification to this embodiment may be a hologram recording medium which has a separation layer interposed between the reflective layer 5 and recording layer 4.

While several shapes can be contemplated for the y-direction positioning mark M, any shape may be employed as long as it can be sensed by the servo beam. For example, the y-direction positioning mark M may be a mirror face portion free of the track, as shown in FIGS. 1 and 2, and otherwise, the y-direction positioning mark M may be an enlarged width portion of a track M1. Besides the mark M may be a notch which is cut into part of the side surface of a track, or a pit disposed between adjacent tracks.

The y-direction positioning mark M may be in the shape of a concavo-convex pit, or a mark of a contrast pattern. Since information of the y-direction positioning mark M can be read by a spot of the servo beam SB, it is possible to identify the mark pitch and track pitch in the track extending direction and the direction perpendicular thereto, and to simultaneously acquire a synchronization signal.

The entire tracks may have a structure of a spiral wound several times or a concentric circle structure.

<Hologram Recording/Reproducing Apparatus>

FIG. 4 generally shows an exemplary configuration of a recording and reproducing apparatus for recording or reproducing information to or from a hologram recording medium to which the present invention is applied.

The hologram recording and reproducing apparatus of FIG. 4 comprises a spindle motor 22 for rotating a disk 2, which is a hologram recording medium, through a turn table; a pickup device 23 for reading a signal from the hologram disk 2 with a light beam; a pickup actuator 24 for holding and moving the pickup in a radial direction (x-direction); a first laser source driving circuit 25; a phase modulator driving circuit PMC; a spatial light modulator driving circuit 26; a reproduced signal processing circuit 27; a servo signal processing circuit 28; a focus servo circuit 29; an xy-direction movement servo circuit 30; a pickup position detecting circuit 31 connected to the pickup actuator 24 for detecting a pickup position signal; a slider servo circuit 32 connected to the pickup actuator 24 for supplying a predetermined signal to the pickup actuator 24; a rotation encoder 33 connected to the spindle motor 22 for detecting a rotational speed signal of the spindle motor; a rotation detector 34 connected to the rotation encoder 33 for generating a rotating position signal of the hologram disk 2; and a spindle servo circuit 35 connected to the spindle motor 22 for supplying a predetermined signal to the spindle motor 22.

The hologram recording and reproducing apparatus comprises a controller circuit 37 which is connected to the first laser source driving circuit 25, phase modulator driving circuit PMC, spatial light modulator driving circuit 26, reproduced signal processing circuit 27, servo signal processing circuit 28, focus servo circuit 29, xy-direction movement servo circuit 30, pickup position detecting circuit 31, slider servo circuit 32, rotation encoder 33, a rotation detector 34, and spindle servo circuit 35. The controller circuit 37 conducts a focus servo control, an x- and y-direction movement servo control, a reproduced position (position in the x- and y-direction) control, and the like related to the pickup through the foregoing circuits connected thereto based on signals from these circuits. The controller circuit 37, which is based on a microcomputer that is equipped with a variety of memories for controlling the overall apparatus, generates a variety of control signals in accordance with manipulation inputs from the user from an operation unit (not shown) and a current operating condition of the apparatus, and is connected to a display unit (not shown) for displaying an operating situation and the like for the user. The controller circuit 37 is also responsible for processing such as encoding of data to be recorded, input from the outside, and the like, and supplies a predetermined signal to the spatial light modulator driving circuit 26 for controlling the recording sequence. Furthermore, the controller circuit 37 performs demodulation and error correction processing based on signals from the reproduced signal processing circuit 27 to restore data recorded on the hologram disk. In addition, the controller circuit 37 decodes restored data to reproduce information data which is output as reproduced information data.

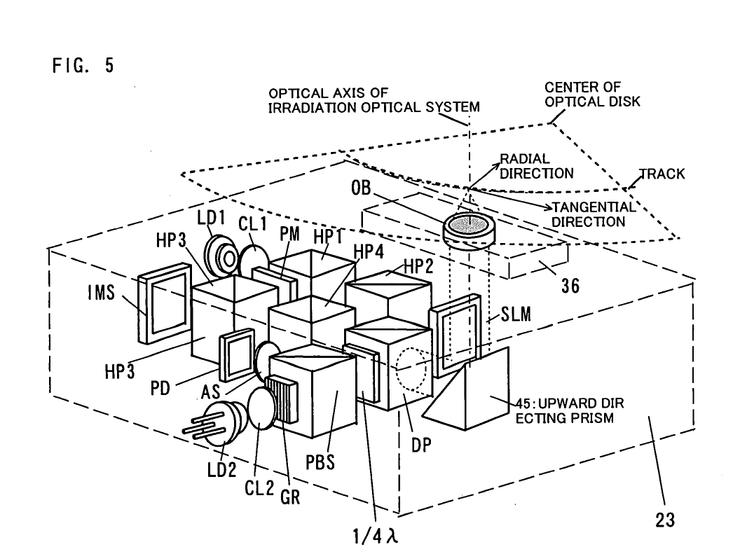

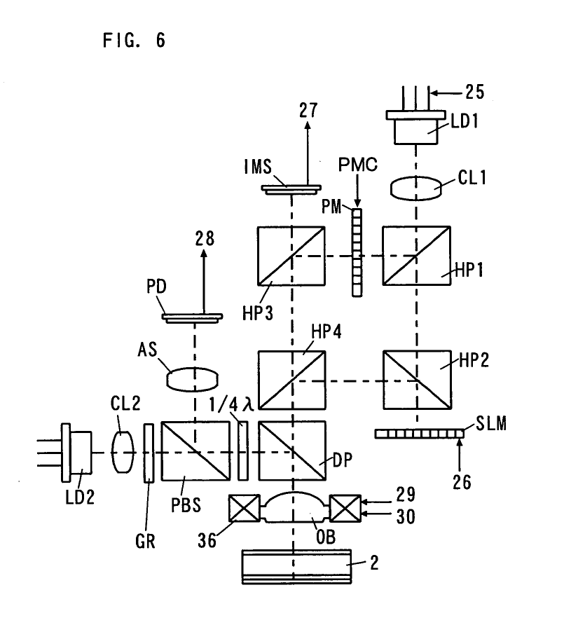

FIGS. 5 and 6 generally show the configuration of the pickup of the recording and reproducing apparatus. The pickup device 23 comprises a recording and reproducing optical system which is made up of a first laser source LD1 for recording and reproducing holograms, a first collimator lens CL1, a first half mirror prism HP1, a phase modulator PM, a second half mirror prism HP2, a spatial light modulator SLM, a reproduced signal detector including an image sensor IMS comprised of an array such as a CCD, a complimentary metal oxide semiconductor device, or the like, a third half mirror prism HP3, and a fourth half mirror prism HP4; a servo system which is made up of an objective lens actuator 36 for servo-controlling (movements in the x-, y-, z-directions) of the position of a light beam with respect to the hologram disk 2, a second laser source LD2, a second collimator lens CL2, a diffraction optical element GR such as a grating or the like for generating a multi-beam for a servo light beam, a polarization beam splitter PBS, a quarter wavelength plate ¼λ, a coupling lens LS, and a servo signal detector including a photodetector PD; and a common system which is made up of a dichroic prism DP and an objective lens OB. These systems are placed substantially on the common plane except for the objective lens OB.

As shown in FIGS. 5 and 6, half mirror surfaces of the first, third and fourth half mirror prisms HP1, HP3, and HP4 are disposed to be parallel with one another. In a normal direction of these half mirror planes, the half mirror plane and the separation planes of the second half mirror prism HP2 and the dichroic prism DP and polarization beam splitter PBS are in parallel with one another. These optical parts are disposed such that the optical axes (one-dot chain lines) of light beams from the first and second laser sources LD1 and LD2 extend to the recording and reproducing optical system and servo system, respectively, and substantially match in the common system.

The first laser source LD1 is connected to the first laser source driving circuit 25, and has its output adjusted by the first laser source driving circuit 25 such that the intensity of an emitted light beam is increased for recording and decreased for reproduction.

The spatial light modulator SLM has a function of electrically transmitting or blocking part or all of incident light with a liquid crystal panel or the like having a plurality of pixel electrodes divided in a matrix shape. The spatial light modulator SLM, which is connected to the first laser source driving circuit 25, modulates in intensity and reflects an light beam so as to have an intensity distribution based on page data to be recorded (two-dimensional data of information pattern such as bright and dark dot pattern or the like on a plane) from the spatial light modulator driving circuit 26 to generate signal light. Te modulation condition for the signal light is created in intensity modulation by changing total mount of data of the information pattern based on a phase modulation pattern given to the reference beam.

The phase modulator PM has a function of electrically transmitting part of incident light using a liquid crystal panel having a plurality of pixel electrodes divided in a matrix form, or the like, while giving a phase difference for modulation, or a function of transmitting overall incident light to make a non-modulation state. The phase modulator PM is connected to the phase modulator driving circuit PMC, and modulates the phase of a transmitted beam so as to have a distribution based on an input phase modulation pattern to generate reference light. In this event, the phase modulation pattern in the phase modulator PM is changed every recording sequence to modulate the phase of the transmitted light. In this way, interference patterns resulting from phase modulation patterns of respective groups of holograms are recorded in a multiplexed form.

The reproduced signal detector including the image sensor IMS is connected to the reproduced signal processing circuit 27.

Further, the pickup device 23 is provided with the objective lens actuator 36 for moving the objective lens OB in the optical axis (x) parallel direction, and in a track (y) parallel direction, and in a radial (x) direction perpendicular to the track.

The photodetector PD is connected to the servo signal processing circuit 28, and has the shape of light receiving element divided for focus and x and y direction movement servo generally used for optical discs. The servo scheme is not limited to an astigmatism method, but can employ a push-pull method. The output signal of the photodetector PD, such as a focus error signal and a tracking error signal etc. is supplied to the servo signal processing circuit 28.

In the servo signal processing circuit 28, a focusing driving signal is generated from the focus error signal, and is supplied to the focus servo circuit 29 through the controller circuit 37. The focus servo circuit 29 drives the focusing section of the objective lens actuator 36 mounted in the pickup device 23, so that the focusing section operates to adjust the focus position of an optical spot irradiated to the hologram disk.

Further, in the servo signal processing circuit 28, x and y direction movement driving signals are generated from x and y direction movement error signals, and supplied to the xy direction movement servo circuits 30. The xy direction movement servo circuits 30 drives the objective lens actuator 36 mounted in the pickup device 23 in response to the driving signals, so that the objective lens actuator displaces the position of the optical spot irradiated to the hologram disk by amounts corresponding to the driving currents carried by the driving signals.

The controller circuit 37 generates a slider driving signal based on a position signal from the operation panel or the pickup position detecting circuit 31 and the x direction movement (tracking) error signal from the servo signal processing circuit 28, and supplies the slider driving signal to the slider servo circuit 32. The slider servo circuit 32 moves the pickup device 23 in the radial direction of the disk in response to a driving current carried with the slider driving signal by the pickup actuator 24.

The rotation encoder 33 detects a frequency signal indicative of a current rotating frequency of the spindle motor 22 for rotating the hologram disk 2 through the turn table, generates a rotational speed signal indicative of the spindle rotational signal corresponding thereto, and supplies the rotational speed signal to the rotation detector 34. The rotation detector 34 generates a rotational speed position signal which is supplied to the controller circuit 37. The controller circuit 37 generates a spindle driving signal which is supplied to the spindle servo circuit 35 to control the spindle motor 22 for driving the hologram disk 2 to rotate.

<Method of Recording and Reproducing Hologram>

Description will be made on a recording method for recording or reproducing information by irradiating a hologram disk with an light beam using the hologram recording and reproducing apparatus described above.

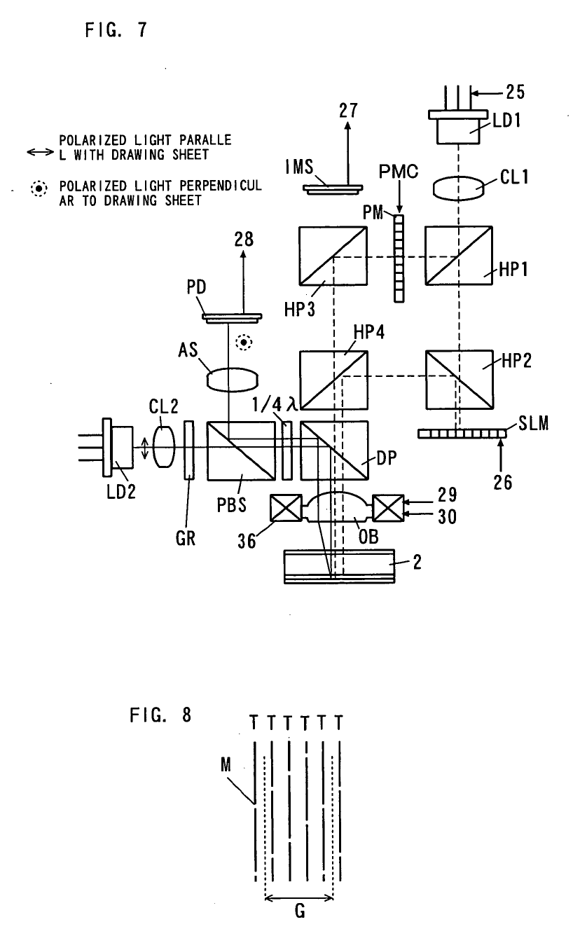

During recording, as shown in FIG. 7, coherent light having a predetermined intensity from the first laser source LD1 is separated into a reference beam and a signal beam by the first half mirror HP1 (both the beams are indicated by broken lines and are shifted from the optical axis of FIG. 6 for explaining the optical path).

The signal beam transmits the second half mirror prism HP2, and impinges on the spatial light modulator SLM along the normal of the reflective surface. The signal light modulated in a predetermined manner by and reflected from the spatial light modulator SLM again impinges on the second half mirror prism HP2 and directs to the fourth half mirror prism HP4.

The reference beam passes through the phase modulator PM and is reflected by the third half mirror prism HP3, and directs to the fourth half mirror prism HP4.

The reference light and the signal light are combined using the fourth half mirror prism HP4. The two combined light beams pass through the dichroic prism DP, and are converged on the hologram disk 2 by the objective lens OB for recording a hologram.

The recording of holograms according to this embodiment is divided into a plurality of recording sequences, such that the recording sequences are sequentially performed for each of the groups of holograms. Further, the recording is performed sequentially in a site of the recording layer adjacent to hologram portions which is least frequently irradiated with light. The recording sequence may be sequentially performed in a site adjacent to the hologram portions which are less irradiated with light from among the group of holograms.

For example, description will be made on a scenario in which a particular area is recorded through two recording sequences up to the recording density of the maximum multiplicity. The particular area may be the overall recording layer, or a block such as a partially determined recording area, a sector, an address region, or the like.

A column of a group of holograms is recorded in each recording sequence as shown in FIG. 8. In this event, the power of a recording laser, or a recording time is assumed to be at a predetermined constant value. The recording time can be determined from the relationship between the multiplex recording time of holograms and the modulation factor.

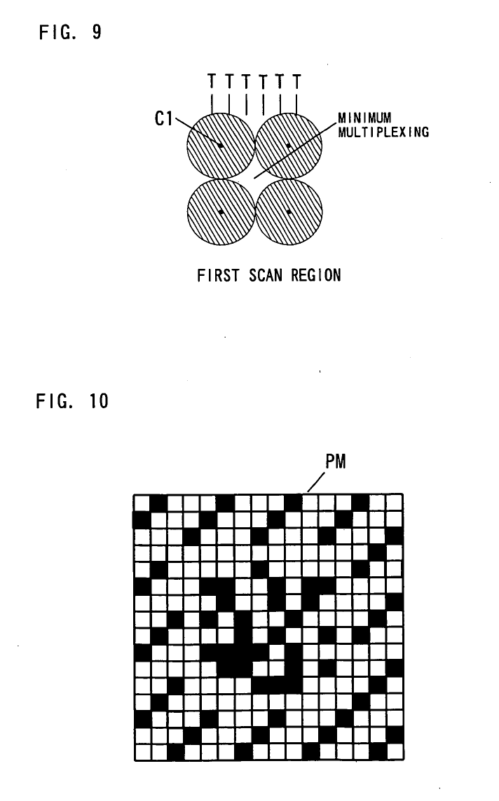

First, as shown in FIG. 9 (first scan region), in the recording sequence for a first hologram group, holograms (center C1) are sequentially recorded such that an overlapping portion is minimized on every four track pitches G, and the recording is repeated until the layer is filled with holograms. In the recording sequence for the first hologram group, the phase of transmitted light is modulated with a first phase modulation pattern of the phase modulator PM, for example, as shown in FIG. 10 to generate first reference light. Consequently, a minimum multiplexing portion remains among the holograms (center C1).

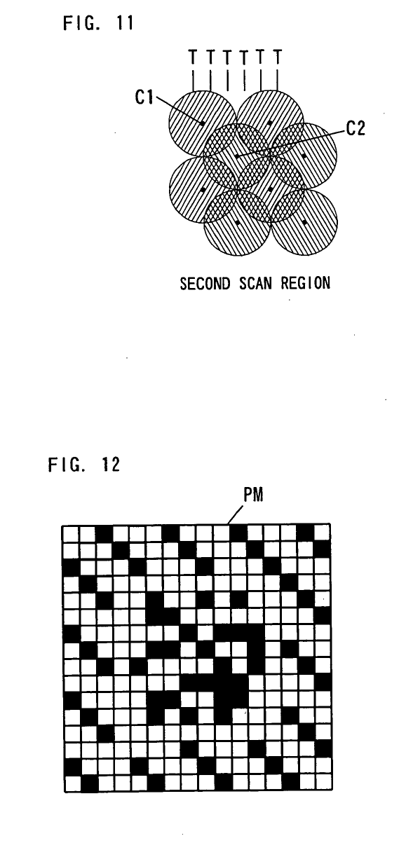

Next, in the recording sequence for a second hologram group, a plurality of columns of holograms (center C2) are sequentially recorded at the hologram recording pitch in a similar manner to the first hologram group, as shown in FIG. 11 (second scan region). In the recording sequence for the second hologram group, the phase of transmitted light is modulated with a second phase modulation pattern of the phase modulator PM, for example, as shown in FIG. 12, to generate second reference light. The recording sequence may be performed in order of the groups of holograms aligned in a spatial position.

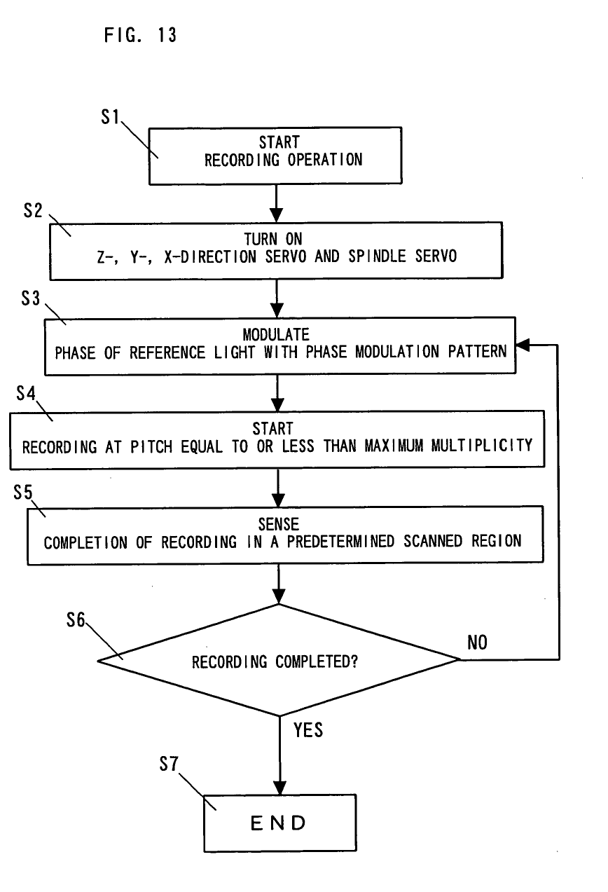

For example, in the recording sequence for the second hologram group, as shown in FIG. 13, as the recording sequence starting step is executed (S1), the servo control in the x-, y-, and z-directions, and spindle servo control are executed (S2), and a step of driving the phase modulator with a predetermined phase modulation pattern to modulate the phase of the transmitted light is executed (S3). Then, the spatial light modulator is driven to start the recording at a wide pitch which results in a low density equal to or lower than the maximum multiplicity (S4), and the recording sequence is maintained until the completion of the recording in a predetermined area, for example, a group of holograms is sensed (S5). Next, it is determined (S6) whether or not the recording completion is sensed, and the recording sequence is terminated if sensed (S7). Otherwise, the flow returns to the phase modulation execution step (S3). The recording is similarly performed in the next recording sequence onward, and the recording is continued until the density of the maximum multiplicity is reached.

When the recording of the second layer is performed on a portion in which the recording of the first layer has been performed, the recording is performed such that the multiplexing portion of the first layer is substantially the same as that of the second layer just in the middle (minimum multiplexing portion) of the hologram recording on the first layer. This method of determining the recording time involves scheduling the recording to make constant the diffraction efficiency of each layer, as is the case with the general multiplex recording scheme of holograms, but only needs to set a recording time on a layer-by-layer basis, thus facilitating the control.

As described above, in this embodiment, the phase modulator PM is disposed in the reference light generation optical system, and is provided with a phase modulation pattern in synchronism with each of a plurality of groups of holograms to modulate the phase of reference light for each recording sequence. Specifically, while the phase of the reference light is modulated constantly in multiplex recording of each group of holograms, a different phase modulation pattern is used for each recording sequence. The phase modulation pattern is fixed during the recording of holograms in each recording sequence. Of course, a different phase modulation pattern can be used for recording a different group of holograms, the modulation pattern is fixed during the recording sequence.

<Method of Reproducing Hologram>

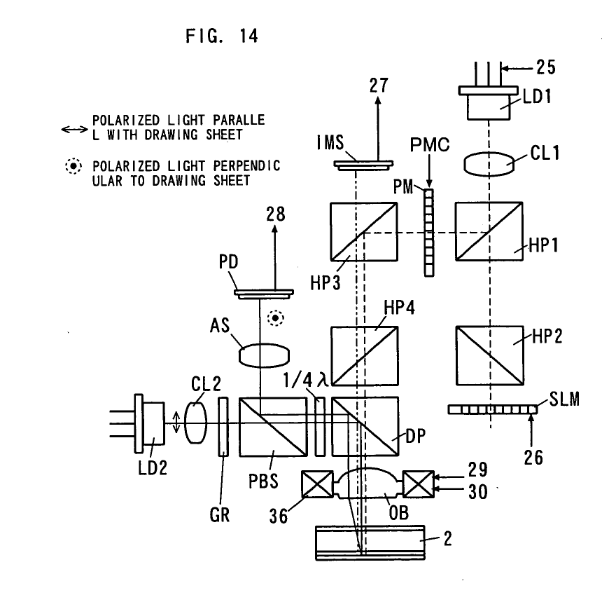

During reproduction, on the other hand, light is separated into a reference beam and a signal beam by the first half mirror HP1, in a manner similar to the recording, as shown in FIG. 14, however, holograms are reproduced only with the reference beam. By bringing the spatial light modulator SLM into a non-reflective state (light-permeative state), only reference light from the third half mirror HP3 passes through the dichroic prism DP and objective lens OB, and impinges on the hologram disk 2.

On the other hand, during reproduction of holograms, the phase modulator PM is driven such that the reference light is in the same phase modulation state as that which was set for the recording to generate a reference beam in a predetermined phase state. Stated another way, for reproducing a group of holograms from among the previously recorded holograms, the phase modulator PM is driven with a pattern which is switched such that the same phase wavefront is produced as the phase modulation of the reference light when the holograms were recorded.

Since reproduced light (two-dot chain line) generated from the hologram disk 2 transmits the objective lens OB, dichroic prism DP, fourth half mirror prism HP4, and third half mirror prism HP3, and impinges on the image sensor IMS. The image sensor IMS delivers an output corresponding to an image formed by the reproduced light to the reproduced signal processing circuit 27 which generates a reproduced signal that is supplied to the controller circuit 37 for reproducing recorded page data. An image forming lens may be provided between the third half mirror prism HP3 and the image sensor IMS.

<Servo Control for Objective Lens>

In this embodiment, some of a plurality of beams are used to perform an x-direction servo which forces the objective lens to follow a track in the x-direction, while one of the plurality of beams is used to perform a y-direction servo for following the y-direction positioning mark M, to record and reproduce the aforementioned holograms. In the positioning servo control, light from the second laser source LD2 is divided into a plurality of servo sub-beams (servo beams) by the diffraction optical element GR, and calculations are made based on outputs of a four-divided photodetector PD which includes light receiving surfaces that receive return light from the respective servo beams, to generate a signal for driving a triaxial actuator (objective lens actuator 36) which can drive the objective lens along the x-, y-, and z-axes.

During both recording and reproduction, the second laser source DL2 for servo control emits coherent light at a different wavelength from the first laser source LD1, as shown in FIGS. 7 and 14. The servo light beam (thin solid line) from the second laser source DL2 is P-polarized light (double-head arrow indicating the parallelism to the drawing sheet) which is led along an optical path for servo detection including the second collimator lens CL2, polarization beam splitter PBS and ¼ wave plate ¼λ, but is combined with the signal beam and reference beam by the dichroic prism DP immediately before the objective lens OB. The servo light beam, after reflected by the dichroic prism DP, is converged by the objective lens OB, and impinges on the hologram disk 2. Return light of the servo light beam reflected from the hologram disk 2 back to the objective lens OB and then transformed by the ¼ wave plate ¼λ into S-polarized light (a black circle surrounded by a broken-line circle indicative of being perpendicular to the drawing sheet) which impinges on a light receiving surface of the servo photodetector PD along the normal thereof through the polarization beam splitter PBS and astigmatism element AS.

Though not particularly shown, a scheme generally used in an optical pickup is used for z-direction servo (focus servo). A push-pull method and also an astigmatism method or the like can be used from the fact that the photodetector PD for servo has four-divided light receiving surfaces.

According to this embodiment, since holograms brought into closer proximity by the multiplex recording are recorded by reference light having different phase wavefronts, cross-talk from adjacent holograms is reduced during reproduction. For this reason, read errors will not increase even if the multiplicity is increased.

Also, since the phase modulator may be switched for the recording on the overall surface of the hologram recording medium with a reduced multiplicity, or each time a particular area is recorded, the control is simple. While the foregoing embodiment has been described in connection with a recording scheme which reaches the maximum multiplicity with two recording sequences, the same is applied to a recording scheme which reaches the maximum multiplicity with a plurality of times of recording sequences. The phase of the reference light may be modulated for each recording sequence, or the phase modulation can be switched only when the closest hologram is eventually recorded.

### OTHER EMBODIMENTS

In the foregoing embodiment, the phase modulator PM is disposed in the reference light generation optical system, and the phase modulator PM is provided with a phase modulation pattern for each group of holograms to modulate the phase of reference light for each group of holograms. Alternatively, there is a second embodiment which does not employ the phase modulator driving circuit PMC and is not provided with the phase modulator PM as shown in FIG. 15.

The second embodiment has the same configuration as the foregoing embodiment except for the omission of the phase modulator PM and phase modulator driving circuit PMC, shown in FIGS. 4-7.

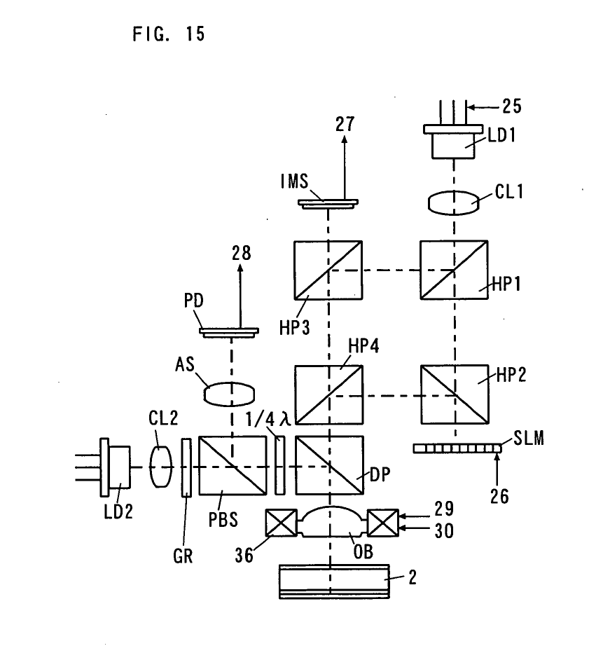

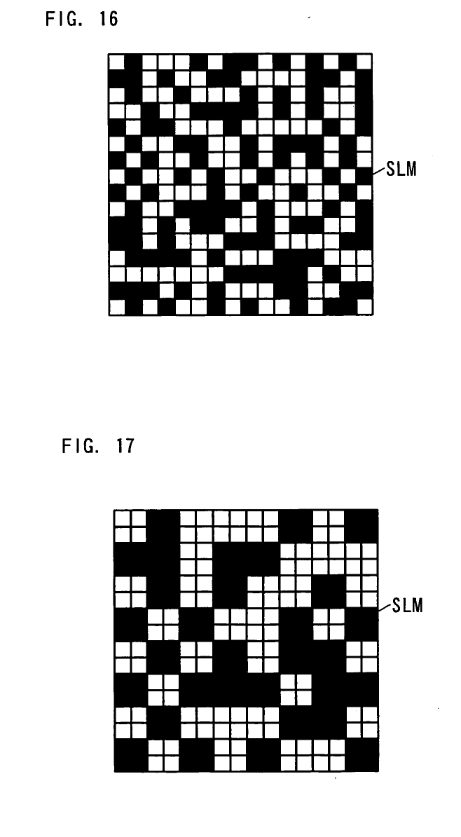

In the second embodiment, for example, a recording sequence for a first hologram group shown in FIG. 9 is conducted using page data of the spatial light modulator SLM having a high resolution as shown in FIG. 16 which is supplied from the spatial light modulator driving circuit 26. Next, a recording sequence for a second hologram group shown in FIG. 11 is conducted using other page data of the spatial light modulator SLM having a low resolution as shown in FIG. 17. In other words, a different resolution is used for each group of holograms. In this event, the page data for signal light has a constant predetermined resolution for each group of holograms.

In this event, as shown in FIG. 18, as a sequence starting step is executed (S11), the servo control in the x-, y-, and z-directions, and spindle servo control are executed (S12), and a step of selecting a resolution for the spatial light modulator is executed (S13). Then, the recording is started with a pitch equal to or smaller than the maximum multiplicity (S14), and the recording sequence is held, for example, until the completion of the recording of a group of holograms is sensed, followed by termination when the completion is sensed (S15). Next, a recorded area is verified to execute a medium situation confirmation step (S16). It is determined whether or not the completion of recording has been sensed (S17), and the recording sequence is terminated when sensed (S18), and otherwise, the flow returns to the resolution selection step (S13). The recording is performed in a similar manner in the next recording sequence onward, and the recording is performed until the maximum multiplicity is reached. The reproduction is performed with non-modulated reference light, the phase of which is not modulated for any of the recording sequences.

Any of the embodiments may employ a recording control scheme which varies the amount of data for information to be recorded in a multiplexing form depending on the degree of deterioration of a hologram recording medium.

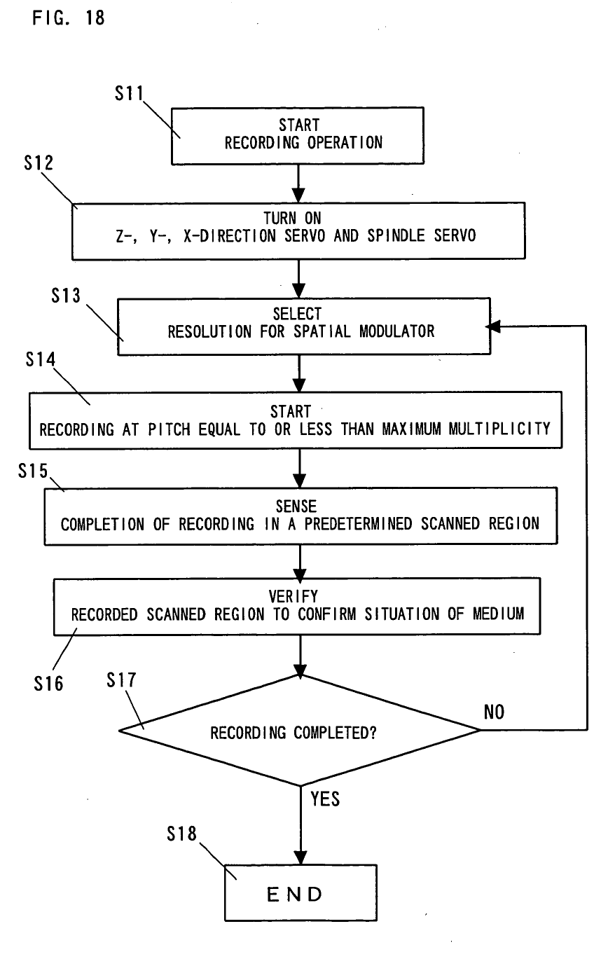

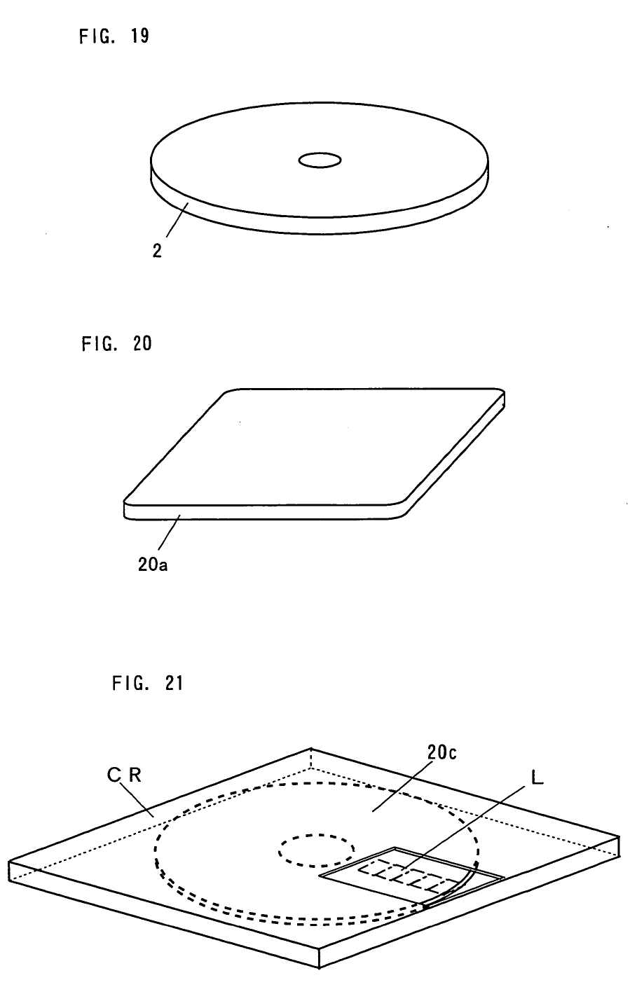

Besides, though the foregoing embodiment includes the hologram disk 2 as shown in FIG. 19 as a recording medium, the shape of the hologram recording medium is not limited to a disk. For example, the embodiment includes as shown in FIG. 20 an optical card 20a of a rectangle parallel flat board made of plastics and the like and having. In such optical card, the guide track may be formed on the substrate spirally or spiroarcually or concentrically with respect to the center e.g., of gravity of the substrate. Further, the guide track may be formed in parallel on the substrate. Also, the hologram recording medium can be made in a variety of shapes such as a disk, a card, and the like. As shown in FIG. 21, a discoidal hologram recording medium 20c including the recording layer can be housed in a cartridge CR having a shatter (not shown) capable of opening and closing a window through which the pickup is accessible.

In the recording method of the present invention, the recording is started from a first hologram group on the hologram recording medium as described above, and holograms are recorded on a group-by-group basis between adjacent tracks. In this way, the centers of adjacent holograms in adjacent hologram groups are displaced from each other without fail. Therefore, when recording or reproducing light is focused, the refractive index at the center of a hologram close to a recording light beam is maintained constant, and causes for disturbing the refractive index are reduced, so that the recording or reproduction can be performed under optimal conditions at all times with a constant recording or reproducing light intensity. Also, the signal quality is stable when the signal is reproduced to accomplish high signal intensity characteristics.

In the recording method of the present invention, if there is a layer which is not used for recording, holograms can be recorded while skipping this layer. Specifically, even if four layers are available for recording, for example, only the first, second, and fourth layers are used without using the third layer, and the recording is started from the fourth layer. Next, the recording is made on the second and first layers, or alternatively the recording is started from the first layer, and then the recording is made on the second and fourth layers. In this way, a high signal quality can be maintained like the foregoing.

In the recording method for the hologram recording medium of the present invention, the recording may be performed over the entire surface of the hologram recording medium, or may be performed block by block, by way of example. Specifically, the medium is divided into a plurality of blocks, such that the recording may be performed sequentially on a layer-by-layer basis in one block, and the recording may be performed similarly in a different block, and may be performed in another different block.

For implementing the recording method as the present invention, the hologram recording medium can be provided with an information identification region which can be used to identify the order of recording on the recording layer. This information identification region may be formed at any position of the medium, and may be formed at any position in the horizontal direction (in a central, marginal, outer peripheral or inner peripheral region). For example, convexo-concave may be embossed on the substrate as information pits in an outer peripheral or inner peripheral region of the hologram recording medium, or may be recorded on the recording layer itself as recording information. Further, even when the hologram recording medium is of the type contained in a cartridge, the cartridge may be formed with convexo-concave, an information identification hole, or the like. In this way, information is previously read from the information identification region before starting the recording to select a recording procedure, thereby making it possible to select an optimal recording method in accordance with this information.

Further, for implementing the recording method of the present invention, the recording and reproducing apparatus can be provided with a recording method identifying means for reading the identification information from the hologram recording medium as mentioned above to determine a recording procedure. The recording scheme identifying method may be a means which can recognize the transmittance, reflectivity, or the like of light directed to a predetermined region of the medium, or information pits such as an embossed pattern formed on the substrate (for example, a photodetector and the like), or a means which can recognize convexo-concave or identification hole formed on the cartridge or the like. In this way, the identification information can be read from the hologram recording medium to determine a recording procedure, thereby selecting an optimal recording method.

According to the foregoing embodiment, the number of times of multiplexing is divided into a plurality of times (a plurality of recording sequences) for recording, and modulation conditions (phase condition, resolution, etc.) are switched for at least one of reference light and signal light in each of the recording sequences, or the modulation conditions are switched only when the most adjacent hologram is recorded, so that holograms in closest proximity to each other are recorded with reference light having different phase wavefronts by the multiplex recording, thus reducing cross-talk from adjacent holograms upon reproduction. Therefore, read errors will not increase even at a higher multiplicity.

Since the modulation conditions may be switched for the recording on the overall surface of the hologram recording medium with a reduced multiplicity, or each time a particular area is recorded, the control is simple. Also, since a small number of phase modulation patterns are sufficient for the reference light, their circuit burden is also small.

Further, when the phase modulator is not used, the resolution of the spatial light modulator can be switched by the number of multiplexing of holograms, so that the recording and reproduction can be made without degrading the modulation factor or error rate by reducing the recording density of information to be subsequently multiplexed, even when the medium is deteriorated due to multiplex recording.

According to the foregoing embodiment, the recording of holograms are preformed per one batch thereof on tracks at a first pitch set to be equal to or larger than a minimum shift distance of holograms, and thus the center of a recording mark does not exist between adjacent tracks to be recorded or between recording marks, thereby making it possible to perform the recording with constant recording power under optimal recording conditions at all times. It is therefore possible to ensure a sufficient intensity of reproduced signal. Moreover, when the recording is performed on a block-by-block basis, the recording can be performed faster. Further, when the hologram recording medium has an information identification region which can be used to identify a recording order to the recording layers, a recording procedure can be selected by previously reading information from the information identification region, thus readily selecting optimal recording conditions.

It is understood that the foregoing description and accompanying drawings set forth the preferred embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese Patent Application No. 2004-36544 which is hereby incorporated by reference.

1. A hologram recording method for forming a light interference pattern in a hologram recording medium to record information thereon, comprising the steps of:
interfering with a reference beam a signal beam spatially modulated by an information pattern which carries the information to generate interfered beams;
executing a recording sequence a plurality of times, the recording sequence including steps of irradiating the interfered beams onto a recording surface of the hologram recording medium to form a group of a plurality of holograms each corresponding to the information pattern; and
completing the recording sequence,
wherein different modulation conditions are set for at least one of the signal beam and the reference beam in one recording sequence and the subsequent recording sequence immediately after the one recording sequence.

2. A hologram recording method according to claim 1, wherein the groups of holograms are in a spatial position overlapping partly each other.

3. A hologram recording method according to claim 1, wherein the groups of holograms are aligned each other in a longitudinal region.

4. A hologram recording method according to claim 1, wherein the modulation condition for said reference beam is created by modulating the phase of said reference beam based on a phase modulation pattern given to said reference beam.

5. A hologram recording method according to claim 1, wherein the modulation condition for said signal light is created in intensity modulation by changing total mount of data of said information pattern based on a phase modulation pattern given to said reference beam.

6. A hologram recording method according to claim 1, wherein the recording sequence is sequentially performed in a site adjacent to the hologram portions which are less irradiated with light from among said group of holograms.

7. A hologram recording method for a hologram recording medium according to claim 1, further comprising a step for making an information identification region including information indicative of an order in which said recording layer is recorded, and said method further includes the step of previously reading the information from said information identification region to select a recording procedure.

8. A hologram recording method according to claim 1, wherein the recording sequence is performed in order of the groups of holograms aligned in a spatial position.

9. A hologram recording method for a hologram recording medium according to claim 1, wherein said groups of holograms are disposed spirally, or spiro-arcually, or concentrically in the hologram recording medium.
